(19) United States
(12) Patent Application Publication
(10) Pub. No.: US 2007/0059207 A1
(43) Pub. Date: Mar. 15, 2007

(54) System and method for high throughput sample loading and processing

(76) Inventors: Linda X. Lin, Fremont, CA (US); Gregory P. Houtz, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/222,618

(22) Filed: Sep. 9, 2005

(51) Int. Cl. G01N 30/02

(52) U.S. Cl. 422/70

(57) ABSTRACT

A chemical sample loading and processing system for high throughput processing, having a processor coupled to a memory, and the memory has located therein at least one data file having a plurality of sets of information, and a software program. The software program includes instructions for the processor to correlate each of the plurality of sets of information in the data file or files with at least one sample, and control the automatic and sequential processing of each of a plurality of samples. The system also includes a stacker, where the stacker holds each of the plurality of samples to be processed and a chemical analyzer coupled to the processor and to the stacker, where the chemical analyzer processes each of the plurality of samples. The data file or files may be at least one of generated in advance of loading of the plurality of samples into the stacker and transferred to the memory and generated in real time as the samples are loaded into the stacker.

### BACKGROUND

Chemical analysis systems and instruments are designed to process and analyze large numbers of samples. These systems are used in various fields, such as, for example, agrochemical, pharmaceutical, cosmetics, petrochemical, etc. Currently, these various fields use different strategies to reduce the processing time of samples, including such methods as simplified chemistry, semi-automation and robotics. Although these methods may reduce the processing time for particular samples, it has not proven effective in reducing the processing time or sample throughput for the system as a whole with respect to multiple and varied samples. As a result, for many years chemical analysis instruments have had a problem of low throughput that, for example, prevents the analytical chemistry screening to catch up to the biology high throughput screening for drug discovery.

In processing and analyzing chemical samples, as the complexity of the chemistry of the sample increases so does the complexity of the processing and analysis and the processing and analysis times involved. Where chemical samples are being processed and analyzed, such as, for example, for the pharmaceutical industry, the processing is usually complicated, and involves a large number of different samples requiring a variety of reagents and processing steps. These multiplicity of samples and different processing requirements results in a much slower throughput for the chemical analysis systems.

These systems are particularly lacking in the ability to function efficiently in an open laboratory environment because of a number of system constraints. For example, existing systems do not provide for the automatic loading of a large number of chemical samples in a single operation as a walk-up process or a pre-operational process, in an open laboratory environment. Another example of a constraint of the existing systems is the lack of multiple individual injection channels that allow for the processing of multiple samples simultaneously or intelligently.

One system currently available in the market and in operation is the Agilent 1100 Auto Well-Plate Sampler that operates using ChemStation software. This system provides for a user to stack a number of microtiter plates containing samples in a single stacker, and allows the user to submit the samples one plate after the other as a “HyperSequence.” This stacking allows the system to queue up the plates. However, this process of sample loading is very inefficient as it requires the user to spend an inordinate amount of time at the Sampler loading and entering information into the system for sample processing and analysis purposes, thereby requiring other users to wait and experience delays in the submission of their samples until the prior user has completed the information entry process.

There is, therefore, a need for a system that provides for expedited sample data entry and loading and reduced waiting time for sample loading by multiple users.

### SUMMARY OF THE INVENTION

The present invention provides a system and method for high throughput sample loading and processing. The present invention solves the problems encountered by the prior art by simplifying the data entry and data preparation process for sample preparation and providing for an autonomous sample load/data grab for sample processing.

The present invention allows a user to prepare samples in any computer by entering the information needed by the system to run the samples and place that information in a file, such as, for example, a CSV file. The file may be placed in a location or on media that can be accessed by the system. The user may then place the samples, for example, plates of samples, with or without barcoding, that the user would like run, in the system. The user may then place the previously prepared file corresponding to the samples in the system at a location for sample-loading files. The user requires no further interaction with the system prior to completion of the sample run. This procedure may be repeated by any number of users. The system will automatically scan the sample-loading file location for sample-loading files. The system will take the sample-loading files and build sequences for each of the samples referenced in the file. The system will then queue to the Hypersequence and run the samples one by one.

A chemical sample loading and processing system for high throughput processing, comprising: a processor; a memory coupled to the processor, the memory having located therein at least one data file having a plurality of sets of information, and a software program, the software program including instructions for the processor to: correlate each of the plurality of sets of information in the at least one data file with at least one sample, and control the automatic and sequential processing of each of a plurality of samples; a stacker, the stacker holding each of the plurality of samples to be processed; a chemical analyzer coupled to the processor and to the stacker, the chemical analyzer processing each of the plurality of samples; wherein the at least one data file is at least one of generated in advance of loading of the plurality of samples into the stacker and transferred to the memory and generated in real time as the samples are loaded into the stacker.

A method for chemical sample loading and processing for a high throughput processing system, comprising: entering sample data for a plurality of samples into a data file; loading the plurality of samples into a chemical analyzer system; transferring the data file to a memory; processing each of the plurality of samples with reference to the sample data in the data file; wherein the sample data for each of the plurality of samples is entered into the data file at least one of prior to the loading of the plurality of samples into the chemical analyzer system and in real time concurrently with the loading of each of the plurality of samples into the chemical analyzer system.

A computer program product for use with a chemical analyzer system, said computer program product comprising: a computer usable medium having computer readable program code embodied therein for chemical sample loading and processing, the computer readable program code including computer readable program code for correlating each of the plurality of sets of information in at least one data file with at least one sample; and computer readable program code for controlling the automatic processing of each of a plurality of samples with reference to corresponding sample data in the at least one data file, wherein the sample data for each of the plurality of samples is entered into the data file at least one of prior to the loading of the plurality of samples into the chemical analyzer system and in real time concurrently with the loading of each of the plurality of samples into the chemical analyzer system.

When a properly formatted file, such as, for example, a CSV file, is added to the sample-loading file location, the system will automatically perform sample loading. This automatic sample loading will allow for the system to perform automatic sample running.

The present invention can be used with and incorporate multiple file formats and content for specific application. It can also be used with multiple and various instruments to accommodate a variety of lab practice standards, requirements and management.

The present invention can also provide for storage of data files and/or the automatic sample loading program at a remote server for download by a user or automatically from the chemical analyzer system through a local area network, wide area network, Internet or other connection.

The system can provide for automatic entry of sample data or manual entry of sample data using a scanner, such as, for example, a bar code scanner in conjunction with labels or other identifying information attached to or maintained in conjunction with the samples.

The present invention provides for improved system throughput and productivity, and allow for automatic sample loading in an open access environment.

### BRIEF DESCRIPTION OF THE DRAWINGS

FIG. 1 shows a block diagram of a system according to an embodiment of the present invention.

FIG. 2 shows a flow diagram of a system setup process according to an embodiment of the present invention.

FIG. 3 shows a flow diagram of an automatic sample loading and processing method according to an embodiment of the present invention.

### DETAILED DESCRIPTION

The term sample refers to a compound or portion of a compound.

The term stacker refers to one or more pieces of equipment for holding samples to be provided for a chemical analyzer.

The term scanner refers to a device, such as for example, a laser or CCD barcode scanner, RFID reader, OCR text reader or some other type of reader, that is used to read information relating to a sample.

The term chemical analyzer refers to an instrument for analyzing the chemical composition, structure, physical or other structure of a sample.

The term sequence refers to running a batch of samples as a single job on a plate (which includes multiple wells for loading samples structured as a 2-dimensional matrix) or on a vial tray (arranged as a 2-dimensional matrix). The samples can be run in any order as is set up in the sequence table. Each sample can each be run using different methods and parameters as set forth in the sequence table. The sequence table is structured as a table having one or more rows and includes information such as row number, sample location, sample type, method name (for running the sample), injection volume and number of injections per location and may include additional information such as target mass, calibration level, among other things. Each row includes all of the parameters required to run an individual sample. The system reads the information in the sequence table sequentially row by row.

The term Hypersequence refers to a ChemStation process whereby one or more sequences are run by the system. A Hypersequence table is created that includes one or more rows of information relating to one or more sequences that are to be run by the system automatically and sequentially in the order as set out in the table. The information that is included in the Hypersequence table includes the row number, the barcode, the plate type, and the sequence name.

The term ChemStation refers to commercially available software from Agilent Technologies, Inc. for controlling Agilent HPLC and LC/MS single quadropole systems all of the elements of which are hereby incorporated by reference.

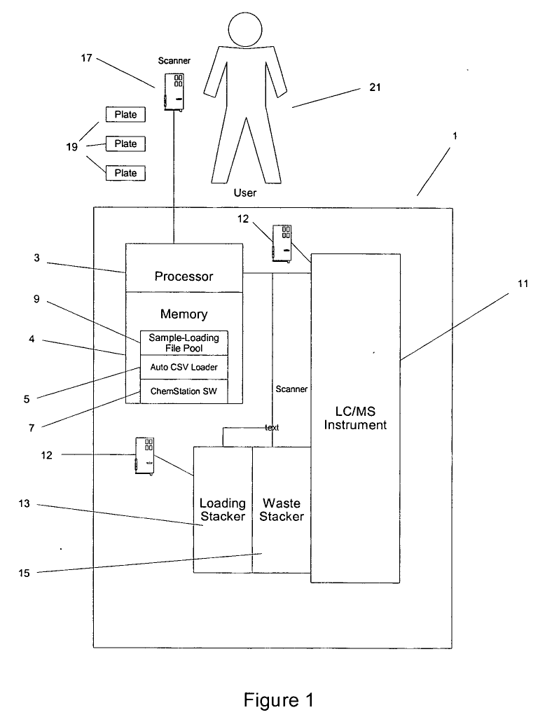

In FIG. 1 there is shown a sample loading and processing system according to an embodiment of the present invention. The sample loading and processing system 1 includes a processor 3 that has loaded on the processor or in memory 4 coupled to the processor an auto CSV Loader program 5 and ChemStation software 7. The processor 3 also includes a memory location known as the sample-loading file pool 9 where the information, or CVS files, are stored. The sample loading and processing system 1 also includes an LC/MS instrument 11 coupled to the processor 3 and a loading stacker 13 and a waste stacker 15 each coupled to the LC/MS instrument 11 and the processor 3. The system also may include a barcode scanner 17 coupled to the processor 3 which is used to scan plates 19 to generate one or more CSV files automatically for user 21. The system also may include one or more additional barcode scanners 12 that are connected to the loading stacker 13 and/or the LC/MS instrument 11.

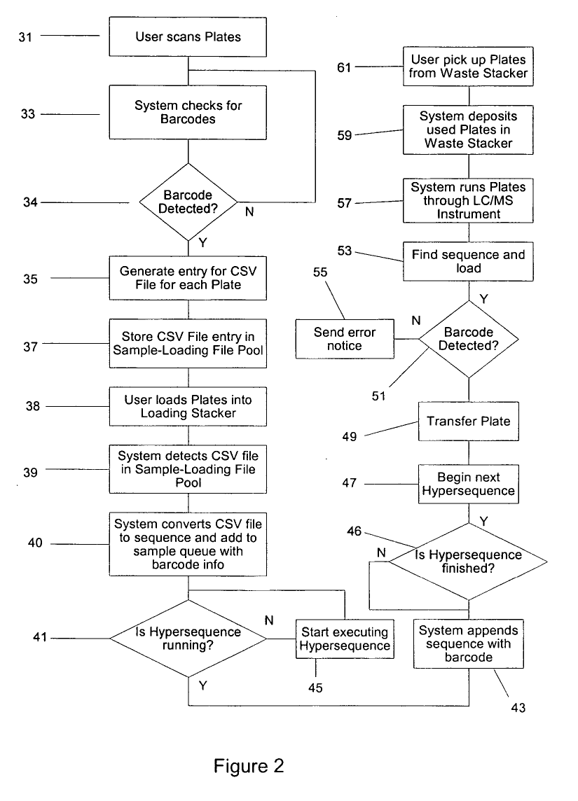

Looking at FIG. 2, there is shown a setup process for the sample loading and processing system of FIG. 1, according to an embodiment of the present invention. In step 31, a user 21 scans each of the plates 19 using the barcode scanner 17. In step 33, the system continuously checks to see whether a new barcode relating to a plate is being detected. In step 34, the system queries whether a barcode is detected. If a barcode is detected then the upon detection of a barcode, in step 35, each scan of a barcode from a plate 19 results in the generation of a CSV file entry for the plate 19 that includes the information contained in the barcode. If a barcode is not detected the system returns to step 33. Alternatively, the user 21 has a CSV file generated in advance for each of the user's plates. The CSV file for each of the plates contains information such as, for example, parameters for running the sample through the system, including method for running the sample, type of sample, sample location, to name just a few. In the embodiment being described, the CSV file information includes sample location, injections per sample, sample type, data file name, sample information, processing method, sample ID, barcode, plate type, and molecular formula.

User 21 can generate the CSV files manually before entering the lab, or use a barcode scanner 17 controlled by a customized software program loaded into the system to scan the plate with a barcode which was registered with or corresponds to information required in the CSV file. The system then generates the CSV file automatically according to the barcode detected. In step 37 the CSV file entry generated by each scan of a barcode is sent to the processor 3 and stored in the sample-loading file pool 9. Alternatively, in step 35, the user 21 may create CSV files manually or by using other software for the plates. This pre-generated CSV file may be loaded by the user 21 into the processor 3 and stored in the sample-loading file pool 9 for automatic upload by the system.

In step 38, the user loads the plates 19 into the loading stacker 11 until the stacker is full, although the user does not have to fill the stacker. User 21 also makes sure the system is up and running with ChemStation software and enables the barcode detection in ChemStation software. Upon completion of a loading of the loading stacker by a user, a next user may begin scanning plates or the loading of a pre-generated CSV file into the sample-loading file pool and loading the plates into the loading stacker 13. A user may alternatively remotely load a pre-generated CSV file into the sample-loading file pool from a remote location. The sample-loading file pool may alternatively be located at a remote server. The operation of user loading plates to the loading stacker does not invoke the system to start running the plates. As in step 39, the “auto CSV loader” software continuously looks for any CSV file left in the sample-loading file pool. In step 40, when the “auto CSV loader” software detects a CSV file in the sample-loading file pool, it automatically reads the CSV file and converts the information in the CSV file to a sequence readable by the LC or LC/MS instrument. In step 41, the system queries whether a Hypersequence is running. If the LC/MS instrument is running a Hypersequence, in step 43 the “auto CSV loader” software appends the sequence linking with the barcode obtained from the CSV file to the Hypersequence table. The sequence contains the sample run information obtained of all samples from the CSV file and places the samples in order. If the LC/MS instrument is not running a Hypersequence at this time, in step 45 the “auto CSV loader” software sends commands to the LC/MS instrument through the ChemStation software to start executing the Hypersequences in the Hypersequence table. If the instrument is running a Hypersequence already, in step 46 an inquiry is made to see whether the current Hypersequence is complete. In step 47, when the current sequence is finished, the next sequence in the Hypersequence table will be queued and executed. If not finished the system continues to query for an end to the Hypersequence.

Once a Hypersequence is executed, in step 49 the system starts transferring the next plate from the loading stacker, and if the barcode scanner 12 in FIG. 1 is enabled, the plate will be scanned with the barcode scanner automatically. In step 51, the system checks to see if a barcode is detected. If a barcode is detected, then in step 53 the system finds the sequence in the Hypersequence table matching the barcode, and loads the sequence to start running the plate, as in step 41. If a barcode is not detected, the system continues to check for a preset number of tries and then sends an error notice, in step 55, if no barcode is detected. In step 57, the system runs the plates through the LC/MS instrument. After the plate is finished running, in step 59, the system moves the plate to the waste stacker. In step 61, the user can remove the plates from the waste stacker when the waste stacker is not in a loading plate process.

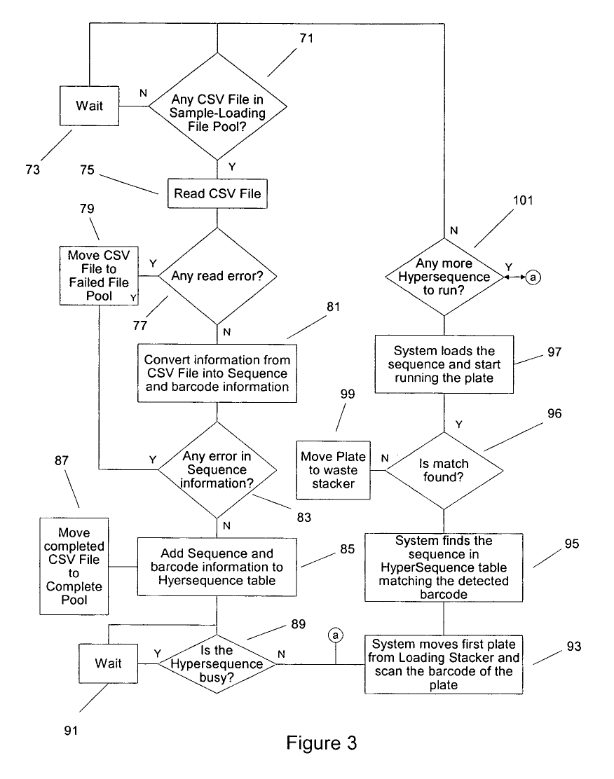

In FIG. 3, there is shown an automatic sample loading and processing method according to an embodiment of the present invention. The method begins with step 71, where a query is made by the processor 3 as to whether there are any CSV files located in the sample-loading file pool 9. If there are no CSV files identified, in step 73 the system sets an internal delay and returns to provide another query pursuant to step 71. If one or more CSV files is identified, in step 75 the computer reads the first CSV file. After reading the CSV file, in step 77 the system checks for read errors. If an error is detected, in step 79, the CSV file in which the error is detected is moved to a failed file pool. This file may be modified, moved back to the sample-loading file pool, or ignored or discarded by user 21.

If no errors are detected in step 77, then in step 81 the information from the CSV file is converted into sequence information recognized by the system to run the samples. After the CSV file is converted, in step 83 the system again checks for errors, this time in the converted data. If an error is detected the file is moved to the failed file pool where it may be modified, moved back to the sample-loading file pool, or ignored or discarded by user 21. If no error is detected, in step 85 the system adds the sequence information linking the barcode from the CSV file to the system Hypersequence storage. In step 87 the CSV file is moved to the complete pool where it can be accessed at a later point in time. In step 89, the system checks and makes sure the Hypersequence is ready to start running for the new plate. If the Hypersequence is not ready the system sets a delay in step 91 and cycles back to the query. If the Hypersequence is ready, in step 93, the system moves the plate from the loading stacker to the barcode scanner 12, and scans the plate. In step 95, when a barcode is detected, the system looks through the Hyperseqeunce storage to find the matching sequence for the plate. In step 96 the system determines whether a matching sequence is found. If a match is found, in step 97, the system will load the correct sequence and start processing the plate. If no matched barcode is found in the Hypersequence storage, in step 99, the system will move the plate to the waste stacker. In step 101, the system periodically queries whether the Hypersequence is idle. If not, the system returns to step 93 and moves the next plate from the loading stacker. Upon a detection of an idle condition of the Hypersequence, the system will return to step 71 and check to see if any files are sitting in the pending pool. If there are files in the pending pool, the system will begin running the file.

What is claimed is:

1. A chemical sample loading and processing system for high throughput processing in an LC/MS instrument, comprising:
a processor;
a memory coupled to the processor, the memory having located therein at least one data file having a plurality of sets of information, and a software program, the software program including instructions for the processor to:
correlate each of the plurality of sets of information in the at least one data file with at least one sample, and
control the automatic and sequential processing of each of a plurality of samples;
a stacker, the stacker holding each of the plurality of samples to be processed;
a chemical analyzer coupled to the processor and to the stacker, the chemical analyzer processing each of the plurality of samples;
wherein the at least one data file is at least one of generated in advance of loading of the plurality of samples into the stacker and transferred to the memory and generated in real time as the samples are loaded into the stacker.

2. The system according to claim 1, wherein the software program is a sample loading program.

3. The system according to claim 1, wherein the memory has located therein a plurality of data files each having at least one set of information.

4. The system according to claim 1, wherein the memory is a first memory having located therein the at least one data file, and further comprising a second memory having located therein a first software program.

5. The system according to claim 4, wherein the first memory is located at a remote server.

6. The system according to claim 1, wherein the at least one data file is generated at a location remote from the chemical sample loading and processing system.

7. The system according to claim 1, wherein the at least one data file is generated using a scanner by reading labels corresponding to each of the plurality of samples.

8. The system according to claim 7, wherein the scanner is a bar code scanner and the labels are bar code labels.

9. A method for chemical sample loading and processing with an LC/MS instrument for a high throughput processing system, comprising:
entering sample data for a plurality of samples into a data file;
loading the plurality of samples into a chemical analyzer system;
transferring the data file to a memory;
processing each of the plurality of samples with reference to the sample data in the data file;
wherein the sample data for each of the plurality of samples is entered into the data file at least one of prior to the loading of the plurality of samples into the chemical analyzer system and in real time concurrently with the loading of each of the plurality of samples into the chemical analyzer system.

10. The method according to claim 9, wherein the sample data is entered using a scanner by scanning labels each corresponding to one of the plurality of samples.

11. The system according to claim 10, wherein the scanner is a bar code scanner and the labels are bar code labels.

12. The method according to claim 10, wherein the sample data is entered into a data file in advance of loading the plurality of samples.

13. The method according to claim 9, wherein the sample data is entered into a data file at a location remote to the chemical analyzer system.

14. The method according to claim 13, wherein the data file is downloaded to the chemical analyzer system after sample data is entered.

15. The method according to claim 9, wherein the data file is stored on a remote server that is accessible from the sample data entry location and by the high throughput processing system.

16. The method according to claim 9, wherein the plurality of samples are loaded into a stacker.

17. The method according to claim 9, wherein the data file is transferred to a memory located at a remote server.

18. The method according to claim 9, wherein the sample data for each of the plurality of samples is entered by scanning information corresponding to the sample concurrently with the loading of such sample into the chemical analyzer system.

19. A computer program product for use with a chemical analyzer system, said computer program product comprising:
a computer usable medium having computer readable program code embodied therein for chemical sample loading and processing, the computer readable program code including:
computer readable program code for correlating each of the plurality of sets of information in at least one data file with at least one sample; and
computer readable program code for controlling the automatic processing of each of a plurality of samples with reference to corresponding sample data in the at least one data file, wherein the sample data for each of the plurality of samples is entered into the data file at least one of prior to the loading of the plurality of samples into the chemical analyzer system and in real time concurrently with the loading of each of the plurality of samples into the chemical analyzer system.

20. A chemical sample loading and processing system for high throughput processing in an LC/MS instrument, comprising:
a processor;
a memory coupled to the processor, the memory having located therein at least one data file having a plurality of sets of information, and a software program, the software program including instructions for the processor to:
correlate each of the plurality of sets of information in the at least one data file with at least one sample, and
control the automatic and sequential processing of each of a plurality of samples;
a stacker, the stacker holding each of the plurality of samples to be processed;
a chemical analyzer coupled to the processor and to the stacker, the chemical analyzer processing each of the plurality of samples;
wherein the at least one data file is at least one of generated at a remote location in advance of loading of the plurality of samples into the stacker and transferred to the memory and generated in real time as the samples are loaded into the stacker using a scanner by reading labels corresponding to each of the plurality of samples.
